(19) United States
(12) Patent Application Publication
(10) Pub. No.: US 2015/0144672 A1
(43) Pub. Date: May 28, 2015

(54) HAND-HELD ELECTRONIC DEVICE

(71) Applicant: HON HAI PRECISION INDUSTRY CO., LTD., New Taipei (TW)

(72) Inventor: SHAO-HAN CHANG, New Taipei (TW)

(21) Appl. No.: 14/482,758

(22) Filed: Sep. 10, 2014

(30) Foreign Application Priority Data
Nov. 22, 2013 (CN) 2013105928252

(51) Int. Cl. F16M 13/00; F16M 13/06

(52) U.S. Cl. CPC F16M 13/005; F16M 13/06
USPC 224/577

(57) ABSTRACT

A hand-held electronic device with a built-in handle includes a main body and a holding member as the built-in handle, arranged on one side of the main body. The main body includes a housing and a display screen. And the holding member can be fully recessed into the main body when not required. The holding member as functions as a support to allow the hand-held electronic device to be freestanding and with a bracket, the hand-held electronic device can be suspended for better viewing.

### FIELD

The subject matter herein generally relates to structure of hand-held electronic devices.

### BACKGROUND

Hand-held electronic devices, such as mobile phones, and tablet computers are very popular. In order to operate the terminal, most of users must use one hand to hold the terminal and manipulate the controls of the terminal by the other hand. The terminal may be dropped, and the display area of the terminal will be obscured by fingers when the terminal is held.

### BRIEF DESCRIPTION OF THE DRAWINGS

Implementations of the present technology will now be described, by way of example only, with reference to the attached figures.

FIG. 1 is a top plan view of an embodiment of a hand-held electronic device.

FIG. 2 is an isometric view of the hand-held electronic device of FIG. 1.

FIG. 3 is an exploded, isometric view of the hand-held electronic device of FIG. 2.

FIG. 4 is an assembled view of the hand-held electronic device of FIG. 2.

FIG. 5 is a perspective view of the hand-held electronic device of FIG. 2 while being held.

FIG. 6 is a perspective view of an unfolded holding member of the hand-held electronic device of FIG. 2.

FIG. 7 is an isometric view of the hand-held electronic device of FIG. 2 coupled to a bracket.

FIG. 8 is an exploded, isometric view of another embodiment of a hand-held electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure describes a hand-held electronic device.

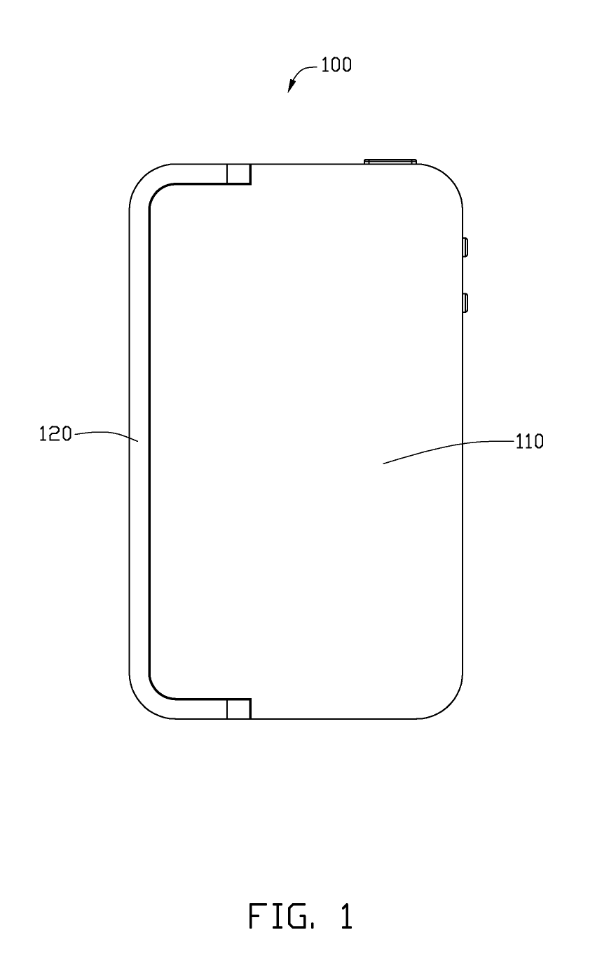

FIG. 1 illustrates a first embodiment of a hand-held electronic device 100. The hand-held electronic device 100 can include a main body 110, and a holding member 120 located at the side of the main body 110.

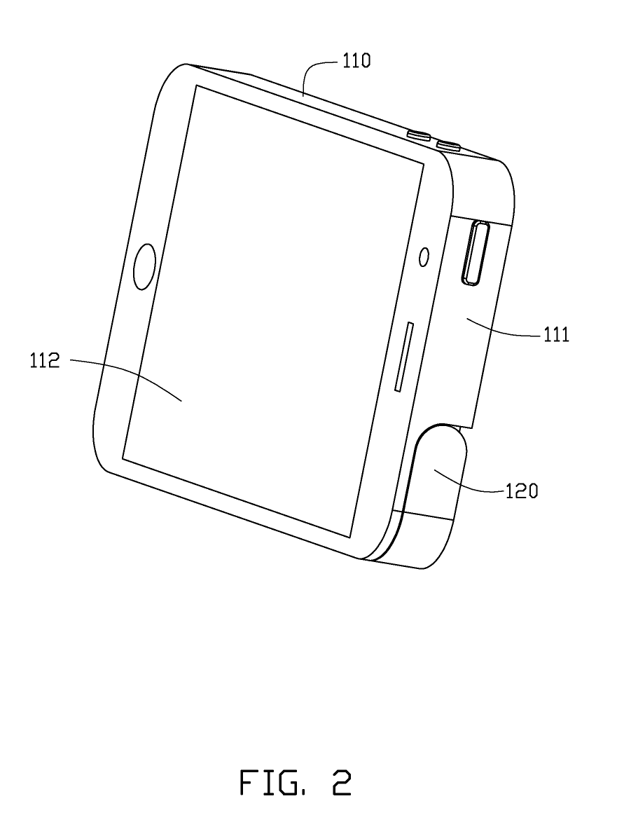

FIG. 2 illustrates that the main body 110 includes a housing 111 and a display screen 112, the holding member 120 can be coupled to the housing 111.

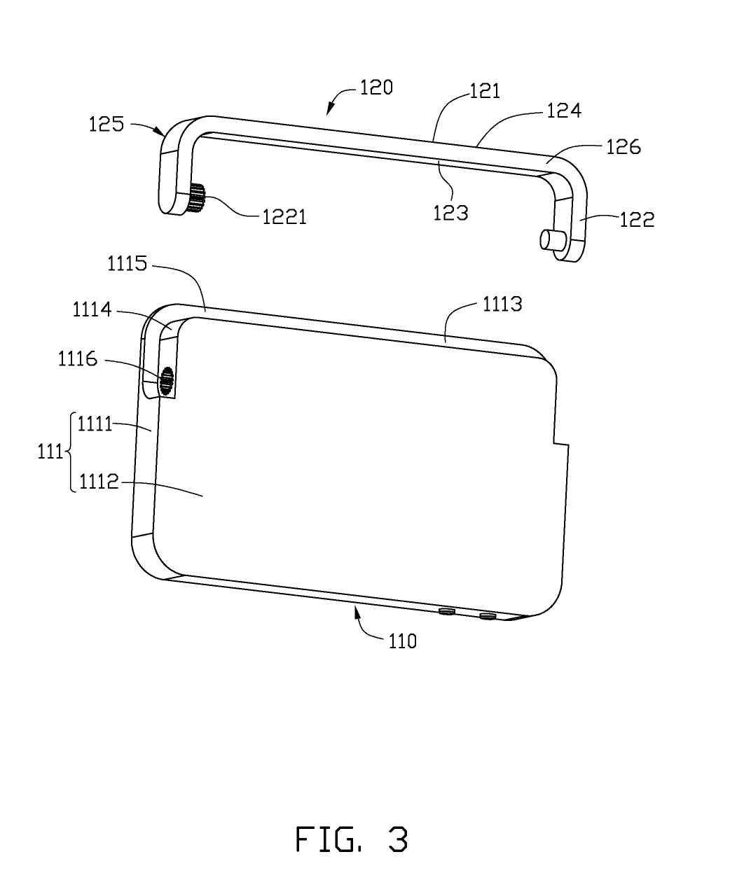

FIG. 3 illustrates that the housing 111 can include a plurality of sidewalls 1111 and a back cover 1112. The housing 111 can further include an indentation 1113 defined by one of the sidewalls 1111 being recessed. The indentation 1113 can include a side surface 1114, a bottom surface 1115 parallel to the back cover 1112, and a pair of matching holes 1116 positioned on the side surface 1114. The indentation 1113 can have a symmetrical U-shape relative to housing 111, and can be configured for installing the holding member 120. The pair of symmetrical matching holes 1116 can be positioned on two terminals of the indentation 1113.

The holding member 120 can include a bar-shaped holding portion 121 and two connecting portions 122. Each connecting portion 122 can extend from an opposite end of the holding portion 121. The holding member 120 can be a symmetrical U-shape, and can be configured for complete installation in the indentation 1113. The holding member 120 can further include a first contacting surface 123, an outer side-surface 124 opposite to the first contacting surface 123, a second contacting surface 125, and an upper surface 126 opposite to the second contacting surface 125. The holding member 120 can further include two pivots 1221. Each pivot can extend inwardly from the two connecting portions 122. The pair of pivots 1221 can be pivotably coupled to the pair of matching holes 1116, and can be configured for the holding member 120 to be rotatably connected to the main body 110. When the holding member 120 is installed in the indentation 1113, the first contacting surface 123 can resist against the side surface 1114, and the width of the first contacting surface 123 can be equal to the width of the side surface 1114. The second contacting surface 125 can resist against the bottom surface 1115, and the width of the second contacting surface 125 can be equal to the width of the bottom surface 1115. The outer side-surface 124 of the holding member 120 can be flushed with one of the plurality of sidewalls 1111, and the upper surface 126 can be flushed with the bottom back 1112 when installation of the holding member 120 in the indentation 1113 is completed.

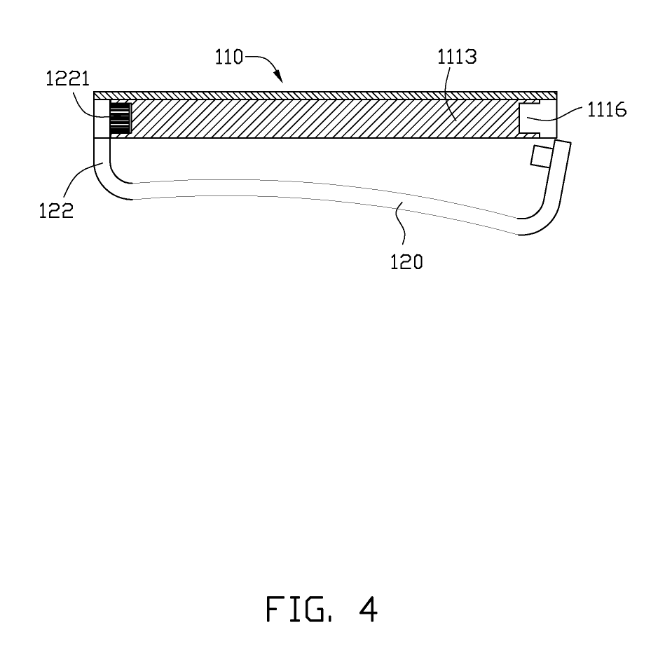

FIG. 4 illustrates that, in assembly, one pivot 1221 of the connecting portion 122 can be pivotably coupled with one matching hole 1116 of the indentation 1113. The other pivot 1221 can be pivotably coupled with the other matching hole 1116 of the indentation 1113 by elastic deformation of the holding member 120, and can be configured for the holding member 120 to be rotatably connected to the main body 110.

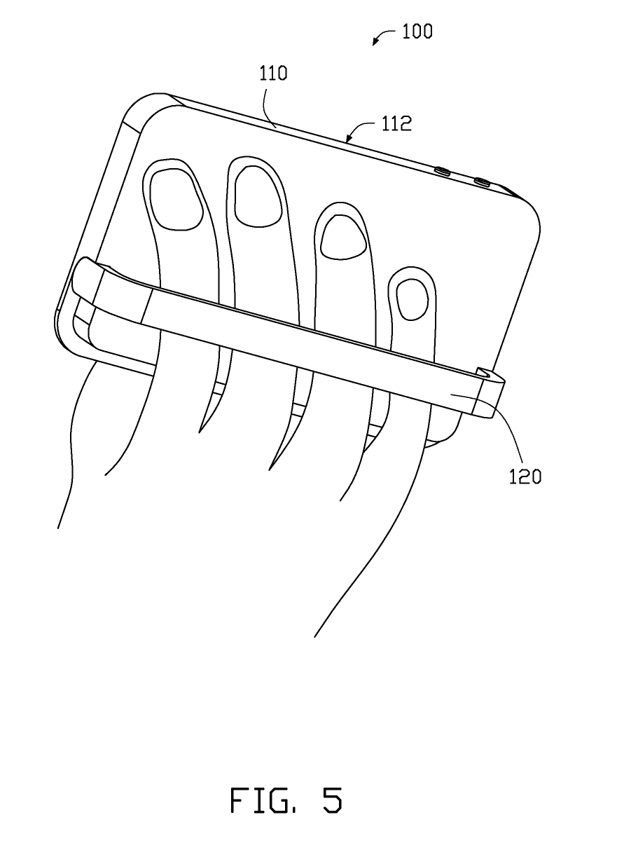

FIG. 5 illustrates that, in use, the main body 110 can be placed on one hand of a user, and several fingers of one hand can pass through the holding member 120. The thumb of one hand is free for touching and controlling the display screen 112. The other hand of user is not required but is available for other tasks. Therefore, the user can better handle the hand-held electronic device 100. In addition, the holding member 120 can be received in the indentation 1113 (shown in FIG. 3) for improving the portability of the hand-held electronic device 100.

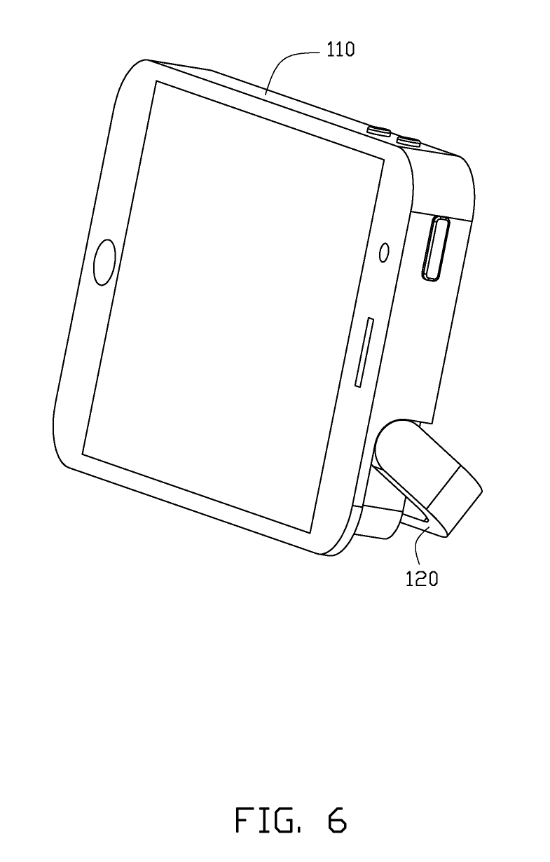

FIG. 6 illustrates that the unfolded holding member 120 can function as a support for the main body 110 when placed on a bearing surface (not shown) such as desk.

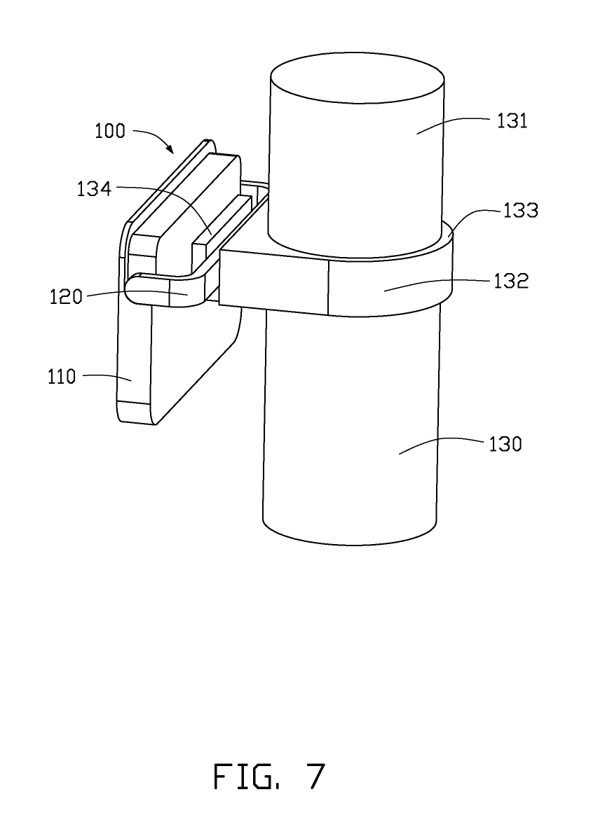

FIG. 7 illustrates that the hand-held electronic device 100 can further include a bracket 130 for the hand-held electronic device 100. The bracket 130 can include a supporting assembly 131 and a rack 132 coupled to the supporting assembly 131. The supporting assembly 131 can be pillar-shaped and configured for steady placement upon a bearing surface (not shown). The rack 132 can be include a collar portion 133 and groove 134 connected with the collar portion 133, and can be configured to engage the holding member 120. The collar portion 133 can be fastened around the supporting assembly 131 for freely adjusting the location of the rack 132. The hand-held electronic device 100 can be suspended by making the holding member 120 engage the groove 134 of the bracket 130. Therefore, the height and inclination of the hand-held electronic device 100 can be adjusted.

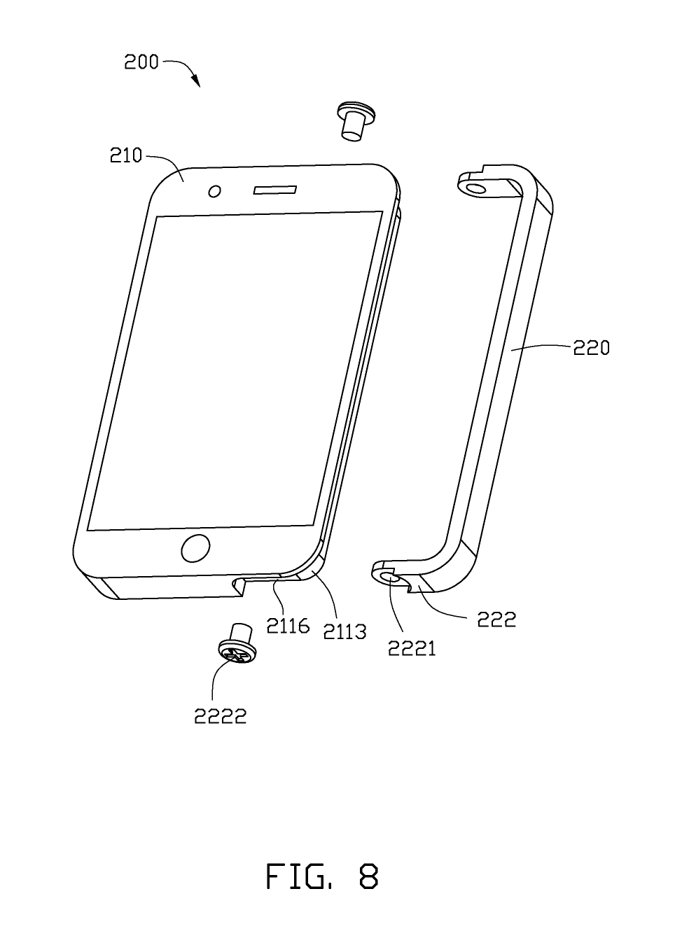

FIG. 8 illustrates a hand-held electronic device 200 in a second embodiment of the disclosure. The hand-held electronic device 200 can include a main body 210, a holding member 220, an indentation 2113, and a pair of matching holes 2116 positioned on two terminals of the indentation 2113. The hand-held electronic device 200 is the same as the first embodiment, except that the holding member 220 can include a pair of connecting holes 2221 on the connecting portions 222. The holding member 220 can be rotatably connected to the main body 210 by coupling the connecting hole 2221 to the matching hole 2116 of the indentation 2113 by a screw 2222.

As described above, the weight and bulk of the hand-held electronic device are not increase by the holding member 120 as a part of the sidewall 1111. The holding member 120 can also function as a support for freestanding the hand-held electronic device 100, and allowing the hand-held electronic device 100 to be suspended on the bracket 130.

The embodiments shown and described above are only examples. Many details are often found in the art such as the other features of a hand-held electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A hand-held electronic device comprising:
a main body comprising a housing and a display screen; and
a holding member rotatably connected to the housing and at least partially receivable within the housing;
wherein, the holding member rotates away from the main body in a direction substantially opposite from the display screen; and
wherein, the housing includes an indentation configured to receive a portion of the holding member when the holding member is rotated into the housing.

2. The hand-held electronic device as claimed in claim 1, wherein the housing further comprises a back cover and a plurality of sidewalls, the indentation is defined on one of the sidewalls.

3. The hand-held electronic device as claimed in claim 1, wherein the holding member comprises a holding portion and two connecting portions respectively vertically extended from two opposite ends of the holding portion, the holding member is rotatably connected to the main body by the connecting portions, and completely installed in the indentation.

4. The hand-held electronic device as claimed in claim 2, wherein the indentation comprises a side surface, a bottom surface parallel to the back cover, and a pair of matching holes positioned on two terminals of the indentation.

5. The hand-held electronic device as claimed in claim 4, wherein the pair of matching holes are symmetrical.

6. The hand-held electronic device as claimed in claim 4, wherein the holding member further comprises two pivots, each of pivots is pivotably coupled to one of the two matching holes, configured for the holding member to be rotatably connected with the indentation.

7. The hand-held electronic device as claimed in claim 4, wherein the holding member further comprises a first contacting surface resisted against the side surface, a outer side-surface opposite to the first contacting surface, a second contacting surface resisted against the bottom surface and a upper surface opposite to the second contacting surface.

8. The hand-held electronic device as claimed in claim 7, wherein the width of the first contacting surface is equal to the width of the side surface.

9. The hand-held electronic device as claimed in claim 7, wherein the width of the second contacting surface is equal to the width of the bottom surface.

10. The hand-held electronic device as claimed in claim 7, wherein the outer side-surface of the holding member is flush with the one of the plurality of sidewalls of the housing.

11. The hand-held electronic device as claimed in claim 7, wherein the upper surface is flush with the bottom back of the housing.

12. The hand-held electronic device as claimed in claim 3, wherein the holding member further comprises a pair of connecting holes and screws, configured for the two connecting portions rotatably connected to the indentation.

13. The hand-held electronic device as claimed in claim 1, wherein the indentation has a symmetrical U-shape relative to the housing.

14. The hand-held electronic device as claimed in claim 1, wherein the holding member has a U-shape with the same shape of the indentation.

15. The hand-held electronic device as claimed in claim 1, wherein the hand-held electronic device further comprises a bracket to suspend the hand-held electronic device.

16. The hand-held electronic device as claimed in claim 15, wherein the bracket comprises a supporting assembly and a rack coupled on the supporting assembly.

17. The hand-held electronic device as claimed in claim 16, wherein the rack comprises a collar portion and groove connected with the collar portion, and is configured to engage to the holding member.
